(19) United States
(12) Patent Application Publication
(10) Pub. No.: US 2022/0119050 A1
(43) Pub. Date: Apr. 21, 2022

(54) CRAWLER-TYPE TRAVELING DEVICE AND IDLER THEREOF

(71) Applicant: Caterpillar SARL, Geneva (CH)

(72) Inventors: Seiji LIJIMA, Akashi-shi (JP); Nobuhiro NAGAMOTO, Akashi-shi (JP); Hayata KONDO, Minato-ku, (JP); Satoshl FUJITA, Kobe-shi (JP)

(73) Assignee: Caterpillar SARL, Geneva (CH)

(21) Appl. No.: 17/428,916

(22) PCT Filed: Jan. 31, 2020
(86) PCT No.: PCT/EP2020/025047

§ 371 Date: Aug. 5, 2021

(30) Foreign Application Priority Data
Feb. 5, 2019 (JP) 2019-019002

(51) Int. Cl. B62D 55/14; B62D 55/08

(52) U.S. Cl. CPC B62D 55/14; B62D 55/08

(57) ABSTRACT

To provide an idler of a crawler-type traveling device which secures the strength while suppressing an increase in the weight and cost, and a crawler-type traveling device provided with the same. An idler includes a hub section that is axially supported; a rim section that is disposed coaxially with the hub section; and plates that connect the hub section and the rim section. At least one of the hub section and the rim section has flange sections that rise toward the other. The plates are mounted to the flange sections.

### TECHNICAL FIELD

The present invention relates to an idler of a crawler-type traveling device including a hub section and a rim section connected by plates, and a crawler-type traveling device provided with the same.

### BACKGROUND ART

Conventionally, among work machines such as construction machines, there are some equipped with a crawler-type traveling device. The crawler-type traveling device is configured such that a sprocket serving as a driving wheel is disposed at one end in a traveling direction of a track frame, an idler serving as a driven wheel is disposed at the other end in the traveling direction of the track frame, and a crawler belt is wound around the sprocket and the idler.

Idlers are available in various structures depending on the sizes of the work machines. For example, there is known an idler having coaxially a hub section which is axially supported and a rim section around which a crawler belt is wound, wherein the hub section and the rim section are connected by a pair of left and right side plates. The side plates are welded to an outer peripheral part of the hub section and an inner peripheral part of the rim section (for example, see Patent Literature 1).

### PRIOR ART LITERATURES

### Patent Literatures

[Patent Literature 1] Japanese Patent Application Laid-Open No. H9-109601

### SUMMARY OF THE INVENTION

### Problems to be Solved by the Invention

In the case of the aforementioned configuration, welded sections between the side plate and the hub section and between the side plate and the rim section are made into parts themselves where the cross-sectional shape changes significantly, namely, parts where the stress is concentrated. For this reason, it is necessary to take measures such as increasing the thickness of members in order to secure the strength so that the stress is not concentrated at the welded sections and cracks are not generated there, and accordingly this leads to an increase in the weight and cost.

The present invention has been made in view of the above points, and an object of the present invention is to provide an idler of a crawler-type traveling device which ensures the strength while suppressing an increase in the weight and cost, and a crawler-type traveling device provided with the same.

### Means for Solving the Problems

The present invention according to a first aspect is an idler of a crawler-type traveling device including a hub section that is axially supported, a rim section that is disposed coaxially with the hub section, and plates that connect the hub section and the rim section, wherein at least one of the hub section and the rim section has flange sections that rise up toward the other, and the plates are mounted to the flange sections.

An idler of a crawler-type traveling device according to a second aspect of the present invention is the idler of the crawler-type traveling device according to the first aspect, wherein the hub section has hub flange sections being flange sections that rise from an outer face toward the rim section, wherein the rim section has rim flange sections being flange sections that rise from an inner face toward the hub, and wherein the plates are mounted by being connected between the hub flange sections and the rim flange sections.

An idler of a crawler-type traveling device according to a third aspect of the present invention is the idler of the crawler-type traveling device according to the second aspect, wherein a plurality of hub flange sections and rim flange sections are formed at different positions in an axial direction of the hub section and the rim section, respectively, and wherein the plates are respectively mounted by being connected between the hub flange sections and the rim flange sections opposed to each other.

An idler of a crawler-type traveling device according to a fourth aspect of the present invention is the idler of the crawler-type traveling device according to the third aspect, wherein the plates are mounted by being connected between the hub flange sections and the rim flange sections at positions deviated from the stress concentration part at the rise of the hub flange sections and the rim flange sections from the hub section and the rim section.

An idler of a crawler-type traveling device according to a fifth aspect of the present invention is the idler of the crawler-type traveling device according to the fourth aspect, wherein the hub flange sections and the rim flange sections of which the tip sides are extended beyond the stress concentration part at the rise from the hub section and the rim section, and wherein the plates are mounted by being connected between the tip sides of the hub flange sections and the tip sides of the rim flange sections.

An idler of a crawler-type traveling device according to a sixth aspect of the present invention is the idler of the crawler-type traveling device according to the fifth aspect, wherein the flange sections are forged integrally, and wherein the plates are welded to the flange sections.

The present invention according to a seventh aspect is a crawler-type traveling device comprising a frame, a sprocket located on one end side of the frame, an idler according to any one of claims 1 to 6, located on the other end side of the frame; and a crawler belt wound around the sprocket and the idler.

### Advantageous Effects of the Invention

According to the first aspect of the present invention, by mounting the plates to the flange sections that rise from at least one of the hub section and the rim section toward the other, the connecting portions of the plates can be located at places deviated from base end portions of the flange sections where there is a significant change of the cross-sectional shape from at least one of the hub section and the rim section, with the result that the need to increase the thicknesses of the plates etc. is eliminated, and the strength can be secured while suppressing the increase in the weight and cost.

According to the second aspect of the present invention, by connecting the hub flange sections that rise from an outer face of the hub section toward the rim section, and the rim flange sections that rise from an inner face of the rim section toward the hub section, by the plates, each of the connecting portions between the hub section and the plate and between the rim section and the plate can be located at positions deviated from the base end portions of the hub flange sections and the rim flange sections where there is a significant change of the cross-sectional shape from the hub section and the rim section, with the result that the strength can be secured while suppressing the increase of the weight and cost.

According to the third aspect of the present invention, by forming a plurality of the hub flange sections and a plurality of the rim flange sections at different positions in the axial direction of the hub section and the rim section, respectively and by connecting the hub flange sections and the rim flange sections opposed to each other by the plates respectively, the strength can be further improved.

According to the fourth aspect of the present invention, because the plates connect the hub flange sections and the rim flange sections at positions deviated from the stress concentration parts of the rises of the hub flange sections and the rim flange sections from the hub section and the rim section, the strength can be ensured without increasing the thickness of the plates etc., and thus the increase of the weight and cost can be surely suppressed.

According to the fifth aspect of the present invention, because the tip end sides of the hub flange sections and the rim flange sections that are extended beyond the stress concentration parts of the rises from the hub section and the rim section are connected by the plates, it is possible to easily obtain a structure in which the stress hardly acts on the connection parts between the plates and the hub flange sections and between the plates and the rim flange sections.

According to the sixth aspect of the present invention, by integrally forging the flange sections, and mounting the plates to the flange sections, the strength can be secured.

According to the seventh aspect of the present invention, by providing the idler according to any one of the first to sixth aspects, a light-weight and low-cost crawler-type traveling device can be provided.

### BRIEF DESCRIPTION OF THE DRAWINGS

FIG. 1 is a longitudinal section view illustrating an embodiment of an idler of a crawler-type traveling device according to the present invention.

FIG. 2 is a perspective section view illustrating the same idler as above.

FIG. 3 is a side view illustrating a working machine provided with a crawler-type traveling device having the same idler as above.

### DETAIL DESCRIPTION OF EMBODIMENTS

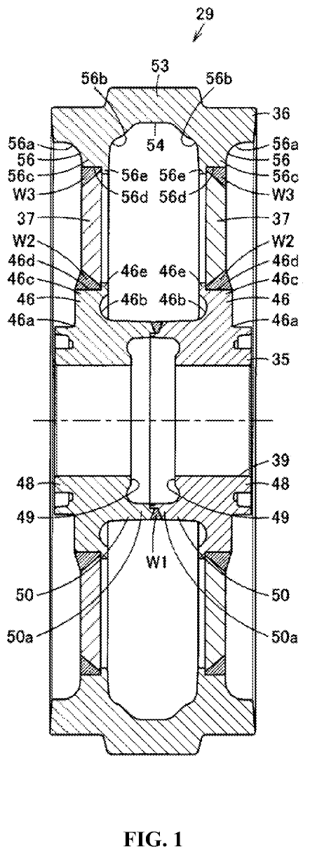

Hereinbelow, the present invention will be described in detail based on one embodiment illustrated in FIG. 1 to FIG. 4.

As illustrated in FIG. 3, a work machine 11 is configured such that an upper revolving structure 12 serving as a vehicle main body is revolvably provided on a crawler-type traveling device 13, and a working device 15 that performs digging work etc., a cab 16 that forms an operator's cab, a power unit 17 such as an engine, and a counterweight 18 are mounted on a revolving frame of the upper revolving structure 12. In the present embodiment, the working machine 11 indicates, for example, a hydraulic shovel type construction machine, but is not limited to the construction machine, and may be an agricultural work machine or the like.

The track frame device 19 comprises a main body frame 22 located in the central part, as a track frame member, and a pair of track frame s 23 (only one part is illustrated), being frames which are formed in long length along the traveling direction of the main body frame 22, and integrated into one side part and the other side part on the left and right with respect to the traveling direction.

The main body frame 22 is provided with a bearing part 24 that supports the upper revolving structure 12 so as to freely be revolved. Further, on the track frame 23, track rollers 26 serving as a plurality of lower rollers are arranged on the lower side thereof and are axially supported so as to freely be rotated, and carrier rollers 27 serving as a plurality of upper rollers are axially supported so as to freely be rotated on the upper side thereof, a sprocket 28 serving as a driving wheel is mounted on one end in a front-rear direction, and an idler 29 serving as a driven wheel is axially supported so as to freely be rotated on the other end in the front-rear direction. Then, a crawler belt 30 is wound around the track rollers 26, the carrier rollers 27, the sprocket 28, and the idler 29, thereby forming a crawler belt traveling device 13 serving as a lower revolving structure.

The sprocket 28 is driven by a traveling hydraulic motor (not illustrated). Further, the idler 29 is urged by a crawler belt tension adjusting device (not illustrated) via the idler support 33 in a direction away from the sprocket 28, and the tension of the crawler belt 30 is adjusted by this urging.

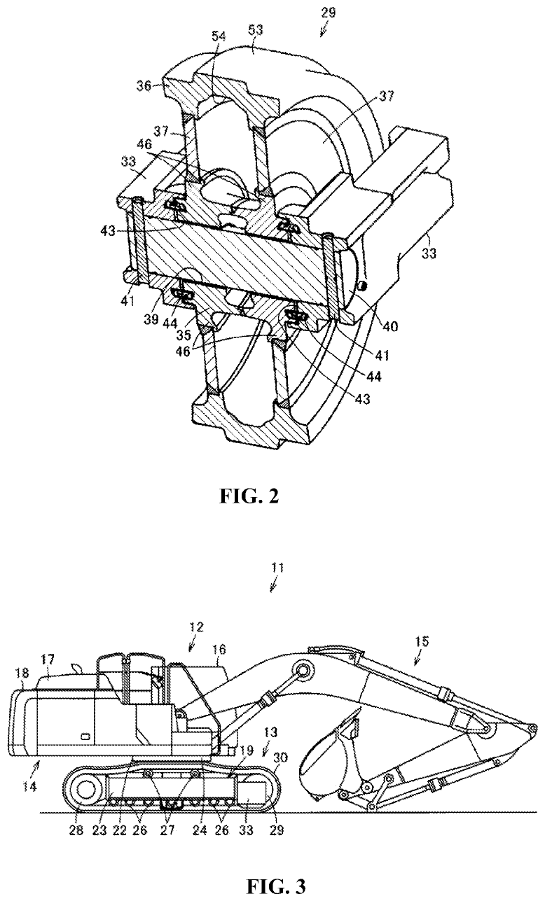

As illustrated in FIGS. 1 and 2, the idler 29 includes a hub section 35 that is axially supported, a rim section 36 that contacts the crawler belt 30, and side plates being a plurality of plates that connect the hub section 35 and the rim section 36.

The hub section 35 is located in the central part of the idler 29. The hub section 35 is formed to have an axial direction along the left and right direction. In the hub section 35, an axle insertion part 39 serving as an axle hole is formed in the central part thereof, and an axle 40 is inserted into the axle insertion part 39. Both ends of the axle 40 project leftward and rightward from the hub section 35 and are integrally fixed by pins 41 to the idler supports 33 located on the left and right of the hub section 35. Therefore, the hub section 35 is axially supported against the track frame 23. The both ends of the hub section 35 opposed to the idler supports 33 are fitted into recesses 43 formed in the idler supports 33. Further, floating seals 44 for sealing a lubricant between the axle insertion part 39 and the axle 40 are disposed by being sandwiched between the both ends of the hub section 35 and the idler supports 33.

Further, a plurality of hub flange sections 46 being flange sections are formed on an outer face, namely, an outer peripheral face of the hub section 35. The hub flange sections 46 are arranged predetermined distance away from each other on the left and right sides in the axial direction of the hub section 35. In the present embodiment, the hub flange sections 46 are arranged each one on the left and right sides of the outer peripheral face of the hub section 35. In short, the hub flange sections 46 are arranged one on the left side and one on the right side in between an axial central part of the hub section 35. The hub flange sections 46 are formed so as to be continued in an annular ring shape to the entire outer peripheral face of the hub section 35. In the present embodiment, the hub flange sections 46 are forged integrally with the hub section 35. Further, the hub flange sections 46 face towards the rim section 36, and rise along a perpendicular or substantially perpendicular direction relative to the axial direction of the hub section 35. Portions where the hub flange sections 46 rise from the hub section 35, i.e., base end portions 46a, 46b of the one and the other of the hub flange sections 46 are smoothly in a curved surface shape continued to the outer peripheral face of the hub section 35. That is, the hub flange sections 46 are formed in a shape in which the cross-sectional shape from the hub section 35 gradually changes, at the base end portions 46a, 46b. In particular, in the present embodiment, the base end portion 46b located on the central part side in the axial direction of the hub section 35 of each hub flange section 46, namely, the base end portion 46b on the right side of the hub flange section 46 on the left side, and the base end portion 46b on the left side of the hub flange section 46 on the right side are formed by being concaved in the thickness direction of the hub flange sections 46 so as to be curved in an arc shape respectively. Consequently, the hub flange sections 46 are formed such that the shape of the base end portion 46b on the central part side in the axial direction of the idler 29 (the hub section 35) has a smoother change of the cross-sectional shape from the hub section 35, compared to the shape of the base end portion 46a facing the outside of the idler 29. The hub flange sections 46 project from the hub section 35 so that tip end portions 46c are sufficiently separated from the base end portions 46a, 46b. That is, the hub flange sections 46 are formed such that the tip end portions 46c extend beyond the base end portions 46a, 46b, which are stress concentration parts of the rises from the hub section 35. More specifically, the hub flange sections 46 are formed such that the tip end portions 46c extend beyond the curved end portions of the base end portions 46a, 46b. Consequently, the tip end portions 46c of the hub flange sections 46 are located at a distance not being affected by the stress concentration.

Furthermore, in the present embodiment, the hub section 35 is divided into a plurality of hub members 48, and is formed in an integral tubular (cylindrical) shape by these hub members 48 being welded to each other. The hub members 48 are formed, for example, so as to divide the hub section 35 into two parts in the axial direction. That is, the hub members 48 are formed in a tubular shape, and arranged by the end parts being butted to each other on the right and left sides. For example, notched section 49 are formed at end parts opposed to each other of the hub members 48 so as to be continued to the axle insertion part 39. The notch sections 49 are formed by concaving the hub members 48 in a direction intersecting with respect to the axial direction. Consequently, positions on the outer peripheral face side of the hub section 35 which are the opposite sides to the axle insertion part 39 serve as butting sections 50 where the hub members 48 are butted against each other. The hub members 48 integrally form the hub section 35 by forming welded sections W1 in which the respective tip end portions 50a are connected by welding. The tip end portions 50a, in the present embodiment, are connected to each other by, for example, V-shaped groove welding. In the present embodiment, the hub flange sections 46 are formed each one on each of the hub members 48. That is, each of the hub members 48 is a forged product with the hub flange section 46 being integrally formed.

The rim section 36 is located at an outer edge of the idler 29. The rim section 36 is formed in an annular ring shape so as to be arranged coaxially with the hub section 35. That is, the rim section 36 is formed to have an axial direction along the left and right direction. The rim section 36 is arranged so as to encircle the outer periphery of the hub section 35. The rim section 36 comprises in an axial central part a protruding section 53 for regulating the left and right positions of the crawler belt 30 (FIG. 3). The protruding section 53 protrudes from an outer face, i.e., an outer peripheral face of the rim section 36, in a direction perpendicular or substantially perpendicular to the axial direction of the rim section 36. The protruding section 53 has a predetermined width in the axial direction of the rim section 36. Further, the back side of the protruding section 53, namely, the center axle side (the hub section 35 side) forms a recessed section 54 so as to suppress a thickness difference from other portions of the rim section 36.

A plurality of rim flange sections 56 being flange sections are formed on an inner face, namely, on an inner peripheral face of the rim section 36. The plurality of rim flange sections 56 are formed depending on the number of the hub flange sections 46 of the hub section 35, namely, the same plural number as the hub flange sections 46. The rim flange sections 56 are arranged a predetermined distance away from each other in the left and right direction that is the axial direction of the rim section 36. In the present embodiment, the rim flange sections 56 are arranged each one on the right and left sides of the inner peripheral face of the rim section 36. In other words, the rim flange sections 56 are arranged one on the right side and one on the left side in between the axial central part of the rim section 36. In the present embodiment, the rim flange sections 56 are arranged at positions where the protrusion section 53 and the recessed section 54 are in the left and right direction interposed. The rim flange sections 56 are formed so as to be continued in an annular ring shape around the entire inner peripheral face of the rim section 36. In the present embodiment, the rim flange sections 56 are integrally forged with the rim section 36. In addition, the rim flange sections 56 face towards the hub section 35, and rise along a direction perpendicular or substantially perpendicular to the axial direction of the rim section 36. Portions at which the rim flange sections 56 rise from the rim section 36, namely, base end portions 56a, 56b of one and the other of the rim flange sections 56 are smoothly continued in a curved surface shape to the inner peripheral face of the rim section 36. That is, the rim flange sections 56 are formed in a shape in which the cross-sectional shape from the rim section 36 changes gradually and smoothly at the base end portions 56a, 56b. In the present embodiment, the rim flange sections 56 are formed such that the shape of the base end portions 56a facing the outside of the idler 29 has a smoother change of the cross-sectional shape from the rim section 36, compared to the shape of the base end portions 56b on the axial central side of the idler 29 (the rim section 36). In addition, the rim flange sections 56 project from the rim section 36 so that the tip end portions 56c are sufficiently separated from the base end portions 56a, 56b. That is, the rim flange sections 56 are formed such that the tip end portions extend beyond the base end portions 56a, 56b, which are the stress concentration parts rising from the rim section 36. More specifically, the rim flange sections 56 are formed such that the tip end portions 56c extend beyond the curved end portions of the base end portions 56a, 56b. For this reason, the tip end portions 56c of the rim flange sections 56 are located at a distance not being affected by the stress concentration. In addition, the rim flange sections 56 are formed in a substantially equal width to that of the hub flange section 46. Furthermore, the tip end portions 56c of the rim flange section 56 are located opposed to (directly opposed to) the tip end portion 46c of the hub flange section 46.

The side plates 37 connect the hub section 35 and the rim 36 at positions of the hub flange sections 46 and the rim flange sections 56 opposed to each other. The side plates 37 are formed in a disk shape (an annular ring shape) so as to cover continuously between the hub flange sections 46 and the rim flange sections 56 opposed to each other. The inner peripheral sides of the side plates 37 are connected by constituting welded sections W2 by welding at the tip end portions 46c of the hub flange sections 46, and the outer peripheral sides of the side plates 37 are connected by constituting welded sections W3 by welding at the tip end portions 56c of the rim flange sections 56. That is, the side plates 37 are mounted by being connected between the hub flange sections 46 and the rim flange sections 56 at positions deviated from the stress concentration parts of the rises of the hub flange sections 46 from the hub section 35, and of the rises of the rim flange sections 56 from the rim section 36, to the hub section 35 and the rim section 36, respectively. In the present embodiment, there are formed face sections 46d and face sections 56d of which curvatures in a direction along the axial direction of the hub section 35 and the rim section 36 become 0 or substantially 0, at the tip end portions 46c of the hub flange sections 46 and the tip end portions 56c of the rim flange sections 56, respectively, and these face sections 46d and the face sections 56d are connected with the side plates 37. The face sections 46d and the face sections 56d, in the present embodiment, are formed at positions facing the outside of the idler 29 at the tip end portions 46c and the tip end portions 56c. For this reason, projecting sections 46e and projecting sections 56e for positioning the side faces of the side plates 37, at the tip end portions 46c and the tip end portions 56c, are formed on the axial central part sides of the hub section 35 and the rim section 36. The side plates 37 are connected to the tip end portions 46c (face sections 46d) of the hub flange sections 46 and the tip end portions 56c (face sections 56d) of the rim flange sections 56, in the present embodiment, by welding in a single bevel groove, for example. The side plates 37 are formed into a thickness substantially equal to a thickness of the hub flange sections 46 and the rim flange sections 56. Consequently, the hub section 35 and the rim section 36 are connected via the side plates 37 in a state in which there is no sudden cross-sectional change between the hub flange sections 46 and the side plates 37 and between the rim flange sections 56 and the side plates 37, so that a hollow wheel-shaped idler 29 is constituted.

Then, the idler 29 is constructed to mount the side plates 37 to the flange sections rising from at least one of the hub section 35 and the rim section 36 toward the other. In the present embodiment, the hub flange sections 46 rising from the outer peripheral face of the hub section 35 toward the rim section 36, and the rim flange sections 56 rising from the inner peripheral face of the rim section 36 toward the hub section 35 are connected by the side plates 37. Consequently, the welded sections W2 and W3, which are the connecting portions between the hub section 35 and the side plates 37 and between the rim section 36 and the side plates 37, can be disposed at position sufficiently separated from the base end portions 46a, 46b and the base end portions 56a, 56b of the hub flange sections 46 and the rim flange sections 56 with a large change of the cross-sectional shapes from the hub section 35 and the rim section. As a result, the base end portions 46a, 46b and the base end portions 56a, 56b with concentrated stresses can be so structured as not to agree with the welded sections W2 and W3 between the hub section 35 and the side plates 37 and between the rim section 36 and the side plates 37. This will eliminate the need to increase the thicknesses of the side plates 37, the hub flange sections 46, the rim flange sections 56, etc. against stresses to improve the strength, thereby enabling to secure the strength of the idler 29 while suppressing an increase in the weight and cost.

The strength of the idler 29 can be further improved by forming the plurality of the hub flange sections 46 and the plurality of the rim flange sections 56 at positions different from each other in the axial direction of the hub section 35 and the rim section 36 respectively, and connecting the hub flange sections 46 and the rim flange sections 56 opposed to each other by the side plates respectively.

The side plates 37 connect the hub flange sections 46 and the rim flange sections 56 at positions deviated from the base end portions 46a, 46b and the base end portions 56a, 56b which are stress concentration parts of the rises of the hub flange sections 46 and the rim flange sections 56 from the hub section 35 and the rim section 36. As a result, the strength can be secured without increasing the thicknesses of the side plates 37, the hub flange sections 46, the rim flange sections 56, etc., thereby enabling to surely suppress the increase of the weight and cost of the idler 29.

Because of connecting the tip end portions 46c, 56c which are extended beyond the base end portions 46a. 46b and the base end portions 46c, 56c which are the stress concentration parts of the rises of the hub flange sections 46 and the rim flange sections 56 from the hub section 35 and the rim section 36, by the side plates 37, the structure of the idler 29 in which the stress hardly acts on the welded sections W2, W3 between the side plate 37 and the hub flange sections 46 and between the side plate 37 and the rim flange sections 56 can be easily obtained.

In addition, by forming smoothly in a curved surface shape the base end portions 46a, 46b and the base end portions 56a, 56b which are the stress concentration parts, their stress concentration can be suppressed.

Furthermore, by forming the face sections 46d and the face sections 56d at the tip end portions 46c of the hub flange sections 46 and the tip end portions 56c of the rim flange sections 56 respectively, and welding between these face sections 46d, 56d through the side plate 37, welding can be easily performed, and at the same time, stresses can be made hard to concentrate on the welded sections W2, W3.

By forming the hub flange sections 46 and the rim flange sections 56 integrally with the hub section 35 and the rim section 36 by forging, and mounting the side plates 37 to the hub flange sections 46 and the rim flange sections 56 by welding, so that the strength the idler 29 can be secured.

Then, by comprising the above idler 29, a light-weight and low-cost crawler-type traveling device 13 can be provided.

Note that, in one embodiment, the hub section 35 is not limited to the one constituted of two hub members 48, and may be constituted of three or more hub members 48, or otherwise may not be divided into plural parts but the entire hub section may be formed integrally.

Further, three or more of the hub flange sections 46 and the rim flange sections 56 may be formed respectively, or only one may be formed.

Furthermore, the flange sections may be provided only on at least one of the hub section 35 and the rim section 36.

### INDUSTRIAL APPLICABILITY

The present invention has industrial applicability, for example, for business operators who manufacture and sell an idler of a crawler-type traveling device used for working machines such as construction machines or agricultural working machines, and working machines equipped with the track-type traveling device.

1. An idler of a crawler-type traveling device comprising:
a hub section that is axially supported;
a rim section that is disposed coaxially with the hub section; and
plates that connect the hub section and the rim section,
wherein at least one of the hub section and the rim section has flange sections that rise toward the other, and the plates are mounted to the flange sections.

2. The idler of the crawler-type traveling device according to claim 1, wherein the hub section has hub flange sections being flange sections that rise from an outer face toward the rim section,
wherein the rim section has rim flange sections being flange sections that rise from an inner face toward the hub, and
wherein the plates are mounted by being connected between the hub flange sections and the rim flange sections.

3. The idler of the crawler-type traveling device according to claim 2, wherein a plurality of hub flange sections and rim flange sections are formed at different positions in an axial direction of the hub section and the rim section, respectively, and
wherein the plates are mounted by being connected between the hub flange sections and the rim flange sections opposed to each other, respectively.

4. The idler of the crawler-type traveling device according to claim 2, wherein the plates are mounted by being connected between the hub flange sections and the rim flange sections at positions deviated from the stress concentration parts of the rises of the hub flange sections and the rim flange sections from the hub section and the rim section.

5. The idler of the crawler-type traveling device according to claim 4, wherein the hub flange sections and the rim flange sections of which the tip end sides are extended beyond the stress concentration parts of the rises from the hub section and the rim section, and
wherein the plates are mounted by being connected between the tip end sides of the hub flange sections and the tip end sides of the rim flange sections.

6. The idler of the crawler-type traveling device according to claim 1, wherein the flange sections are forged integrally, and
wherein the plates are welded to the flange sections.

7. A crawler-type traveling device comprising:
a frame;
a sprocket located on one end side of the frame;
an idler according to claim 1, located on the other end side of the frame; and
a crawler belt wound around the sprocket and the idler.
